(19) United States
(12) Patent Application Publication
(10) Pub. No.: US 2006/0012944 A1
(43) Pub. Date: Jan. 19, 2006

(54) Mechanically operable electrical device

(76) Inventor: Hrand Mami Mamigonians, London (GB)

Correspondence Address: James C Wray, 1493 Chain Bridge Road, Suite 300, McLean, VA, 22101, US

(21) Appl. No.: 10/533,540

(22) PCT Filed: Oct. 31, 2003
(86) PCT No.: PCT/GB03/04709

§ 371 Date: May 2, 2005

(30) Foreign Application Priority Data
Oct. 31, 2002 (GB) 0225315.1
Oct. 31, 2002 (GB) 0225316.9

(51) Int. Cl. H01G 4/005

(52) U.S. Cl. 361/303

(57) ABSTRACT

A mechanically operable electrical device (102), comprising a transmitter electrode (302), a receiver electrode (312) and a moveable conductive element (201). The device is configured such that the conductive element is moveable to a first position remote from said electrodes such that the transmitter electrode is capacitance coupled to said receiver electrode, and the conductive element is moveable to a second position closer to the electrodes such that the capacitance coupling is reduced.

### BACKGROUND OF THE INVENTION

1. Field of the Invention

The present invention relates to a mechanically operable electrical device.

2. Description of the Related Art

Electrical switches comprising of a pair of electrodes which are brought into contact to complete a circuit are well known. A potential problem with some such switches is that repetitive use causes mechanical wear of the electrodes and consequent failure.

In addition, code reading devices are known such that when a coded card to be read is inserted, conductive patches of the card electrically connect selected electrodes of the device to complete electrical circuits. However, due to abrasion by the connecting electrodes, the conductive patches may become worn and lead to incorrect reading of the code.

### BRIEF SUMMARY OF THE INVENTION

According to a first aspect of the present invention, there is provided a mechanically operable electrical device, comprising a transmitter electrode, a receiver electrode and a moveable conductive element, wherein: said device is configured such that said conductive element is moveable to a first position remote from said electrodes such that said transmitter electrode is capacitance coupled to said receiver electrode; and said conductive element is moveable to a second position closer to said electrodes such that said capacitance coupling is reduced.

According to a second aspect of the present invention, there is provided code reading apparatus, and a coded object having one or more conductive regions at defined locations to define a code, wherein said device comprises: a plurality of capacitor devices each having a transmitter electrode and a capacitance coupled receiver electrode; a signal generating device configured to supply a signal of a predetermined type to each said transmitter electrode; and a signal analysing means for analysing a received signal received by said receiving electrodes, wherein said code reading device is configured to receive said one or more conductive regions of said coded object such that the capacitance coupling between the electrodes of one or more corresponding capacitor devices is modified, whereby the signal received at one or more corresponding receiving electrodes is modified.

According to a third aspect of the present invention there is provide a document interpreting system comprising location detection means under which may be placed one or more documents and for detecting the location of pointing means directed at an area of a topmost document of the one or more documents, speech storage means for storing speech relating to different areas of said one or more documents, and speech reproduction means for reproducing speech stored in said speech storage means corresponding to the area of said topmost document to which said pointing means is directed, wherein said pointing means comprises electronic pointing means coupled to said document interpreting system and adapted in use to be directed at any arbitrary area of said topmost document, said location detecting means being arranged to detect electronically the location of said arbitrary area for causing speech stored in said speech storage means corresponding to the arbitrary area of said topmost document to which said pointing means is directed to be reproduced, wherein said location detecting means comprises a transparent or translucent membrane through which the electronic pointing means is directed at the arbitrary area of said topmost document.

Such a system enables, for example, a user to point to any part of a document which is being read and to obtain a spoken version of any text e.g. words, phrases, sentences, etc in the vicinity of a pointer or a spoken description of any picture in said area. It would also be possible for the spoken version or description to be in a foreign language thereby assisting foreign language learning. It is to be noted that the document being read may be in its original form and does not require any additional matter, e.g. bar codes for its interpretation.

An exemplary embodiment of the invention will now be described With reference being made to the accompanying drawings.

### BRIEF DESCRIPTION OF THE SEVERAL VIEWS OF THE DRAWINGS

FIG. 1 shows an electrical appliance 101 embodying the present invention;

FIG. 2 shows an exploded perspective view of components of the linear array of button switches 101;

FIGS. 3A and 3B show a front and rear view of the PCB 206 respectively;

FIGS. 4A and 4B illustrates the operation of the button switch 102;

FIG. 5 shows a diagram of a circuit used to determine the status of the button switches 102 to 105;

FIG. 6 shows signals which illustrate the operation of the circuit of FIG. 5;

FIG. 7 shows an exploded perspective view of components of the rotary switching device 106;

FIGS. 8A and 8B show front and rear views respectively of the PCB 704;

FIG. 9 show an alternative rotary switching device 900;

FIG. 10 shows an electronic apparatus 1001 and a card 1002 used with the apparatus 1001;

FIG. 11 shows the code reader 1008 and the card 1002 of FIG. 10;

FIGS. 12 and 13 show the facing surfaces of the printed circuit boards 1120 and 1121 respectively;

FIGS. 14A and 14B show cross-sectional views of capacitor devices of card reader 1008 which illustrate their operation;

FIG. 15 shows a diagram of the electronic circuitry 1501 of card reader 1008; and

FIG. 16 shows an alternative card reading arrangement for the toy 1001.

FIG. 17 shows a diagrammatic representation of a document interpretation system in accordance with the present invention;

FIG. 18 depicts in greater detail the appearance of a topmost card shown in FIG. 17 which is useful in explaining the operation of the system of FIG. 17;

FIG. 19 shows a block schematic diagram of the document interpretation system of FIG. 17; and

FIG. 20 is a flow diagram relating to the document interpretation system of FIGS. 17 and 19.

### WRITTEN DESCRIPTION OF THE BEST MODE FOR CARRYING OUT THE INVENTION

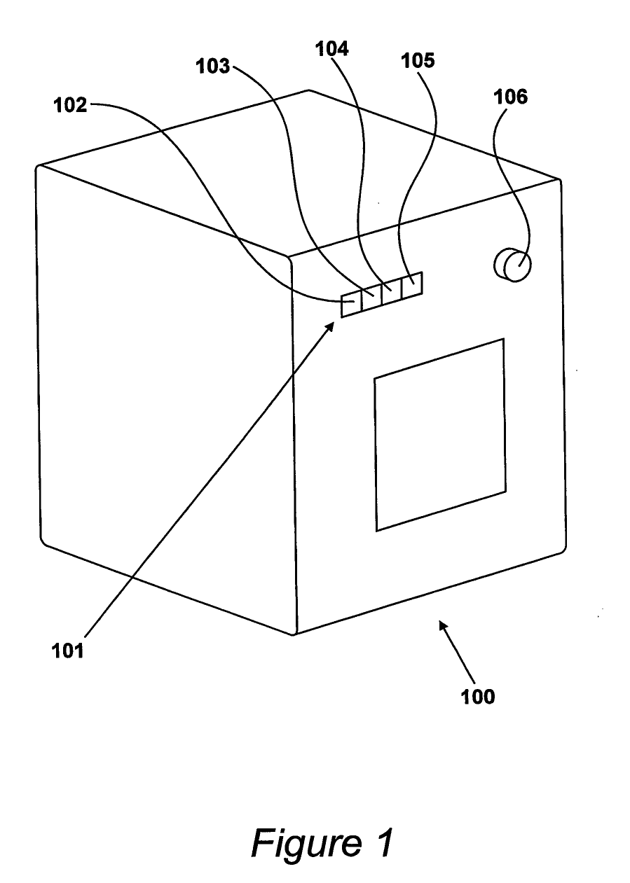

FIG. 1.

An electrical appliance 101 embodying the present invention is shown in FIG. 1. The appliance 100 has a linear array 101 of four manually operable push button switches 102, 103, 104 and 105 which allow a user to select functions of the appliance. In addition, the appliance 101 has a rotary switching device 106 which may be manually rotated to one of five positions to allow a further optional selection to be made.

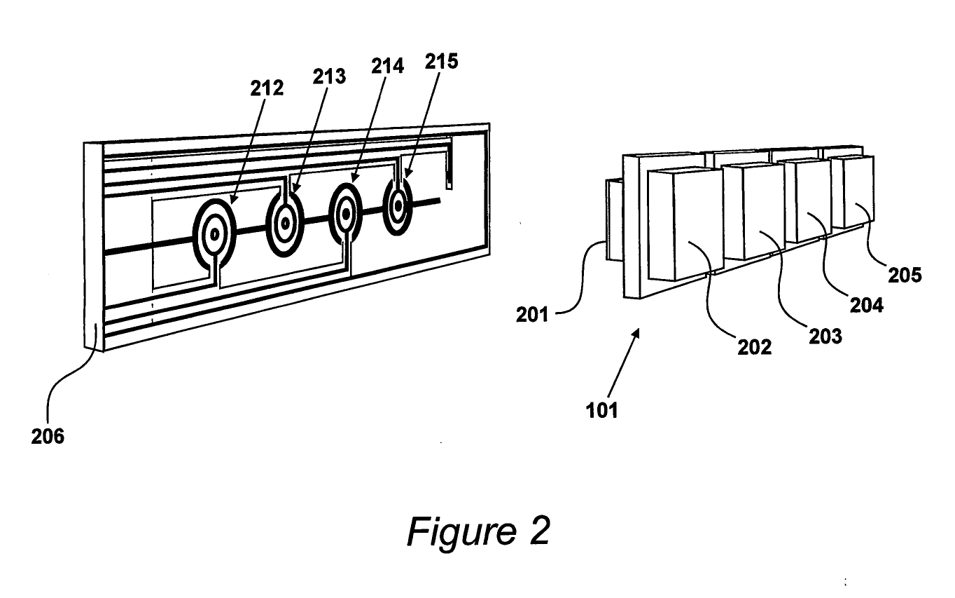

FIG. 2

An exploded perspective view of components of the linear array of button switches 101 is shown in FIG. 2. Each of the four switches 102 to 105 in the array comprises of a button portion, 202, 203, 204 and 205 respectively. The button portions are configured to be depressed by finger pressure, and they are subject to spring mechanisms (not shown) which return them to their original positions after being pressed and released. The buttons may also be subject to a mechanism which maintains their position after depression, until they are re-pressed. Such mechanisms are known in the art.

The button portions 202 to 204 are manufactured from an electrically insulating material such as a plastics material. An electrically grounded (earthed) conductive element, made from a rectangular piece of metal, is rigidly attached to the rear side of each button portion. Thus, for example, conductive portion 201 is rigidly attached to the rear surface of button portion 202.

The linear array 101 of button switches also contains a printed circuit board (PCB) 206, which defines a capacitor device 212, 213, 214, and 215 for each of the button switches 102 to 105 respectively.

When the button portions are not depressed, the conductive portion 201 is located remotely from the corresponding capacitor device 212. For example, it may be positioned ten millimetres away. Upon depression of the button portion, the conductive element 201 is relocated to a position relatively near to the capacitor device 212, for example two millimetres away. The consequential electrical effects on said capacitor device are detected as will be described below.

The conductive element 201 is never brought into contact with electrodes of the capacitor device 212. To ensure this contact does not take place, the conductive element and/or the electrodes of the capacitor device are covered with an insulating layer, for example, a plastic layer or coating. Alternatively, the movement of the button portion may be mechanically limited to ensure the conductive element cannot make contact upon the PCB.

In an alternative embodiment, the PCB 206 is replaced with a plastic membrane supporting conductive material, such as a conductive ink, defining the capacitance devices and the corresponding tracks providing electrical connections to said devices.

It should be understood that although switch array 101 has been described by way of example to have four button switches, other switch arrays embodying the present invention may be produced with more or less than four such switches. Thus, in the simplest case, the switch array comprises a single button switch.

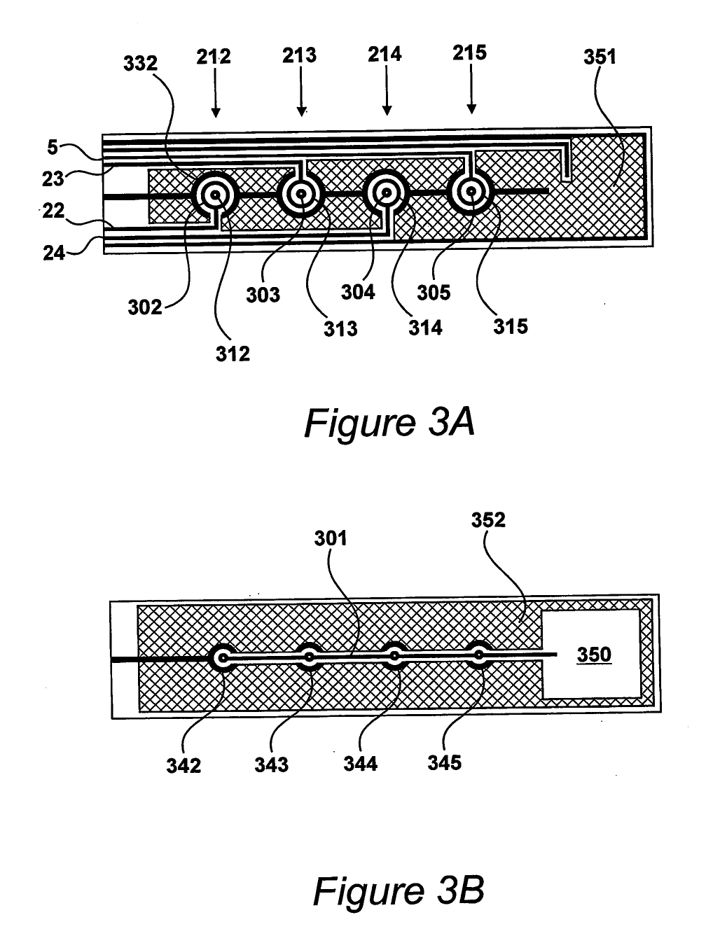

FIGS. 3A and 3B

A front and rear view of the PCB 206 is provided by FIGS. 3A and 3B respectively.

The capacitor devices 212 to 215 each comprise of a transmitter electrode 302, 303, 304 and 305 respectively and a receiver electrode 312, 313, 314, 315 respectively. Each transmitter electrode takes the form of an open circular element which is concentric with a smaller circular element defining the corresponding receiver electrode. Tracks 322 to 325 on the front surface of the PCB provide individual electrical connection to corresponding transmitter electrodes 302 to 305 respectively. The receiving electrodes 312 to 315 are connected to a common track 301 on the rear of the PCB 206 via plated through holes in the PCB. One end of the track 301 terminates in a region 350 of the PCB which supports electronic circuitry for processing signals received by the receiving electrodes.

Hatched areas 351 and 352 on the front and rear of the PCB are electrically grounded. In additions conductive circular arcs 332 to 335 are arranged concentrically around the capacitor devices 212 to 215 respectively on the front surface of the PCB, and conductive circular arcs 342 to 345 are arranged concentrically around the receiving electrodes 312 to 315 respectively on the rear surface of the PCB. The arcs 342 to 345 and 332 to 335 are also electrically grounded.

The close proximity of the electrically grounded elements 342 to 345 and 332 to 335 ensures that spurious signals received at the receiving electrodes caused by external radiation are kept to within tolerable limits.

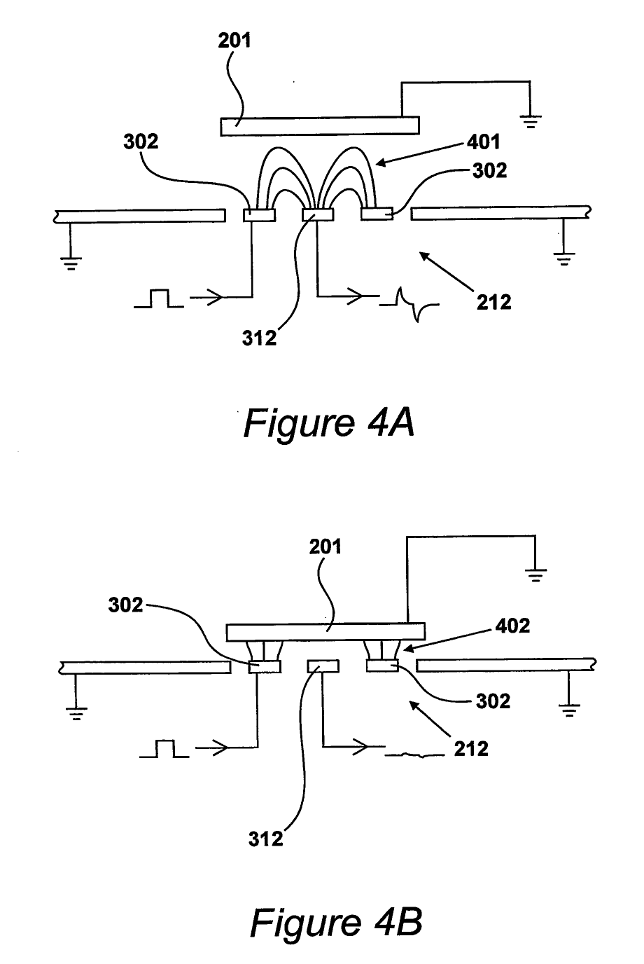

FIGS. 4A and 4B The operation of the button switch 102 is illustrated in FIGS. 4A and 4B.

The button switch 102 is shown in the non-pressed configuration in FIG. 4A. Consequently, the gap between conductive element 201 and the capacitor device 212 is large compared to the relatively small gap of FIG. 4B where the switch is shown depressed.

During operation of the appliance 101, a series of square electrical pulses are applied to the transmitter electrode 302 and the resulting signal received at receiving electrode 312 is analysed to determine whether the button switch 102 is depressed or not.

When the moveable conductive element 201 is remote from the device 212, as shown in FIG. 4A, the close proximity of the transmitter electrode 302 and the receiver electrode 312 provides sufficient capacitance coupling between said electrodes to allow the signal received at the receiver electrode to be detected. In contrast, when the moveable conductive element 201 is close to the device 212, as shown in FIG. 4B, the closeness of said conductive element reduces the capacitance coupling between the transmitter and receiver electrodes such that the received signal is significantly reduced in amplitude.

Example lines of electrical flux 401 and 402, established during the application of the square pulse to the transmitter electrode 302, are illustrated in FIG. 4A and 4B respectively. The flux lines 401 illustrate how an electric field is generated between the transmitter electrode 302 and receiver electrode 312, when the button switch is not depressed. Whereas, when it is depressed, the close proximity of the conductive element 201 modifies the electric field such that the flux 402 between the transmitter electrode 302 and the conductive element 201 is increased and that between the transmitter electrode and receiving electrode 312 is correspondingly decreased.

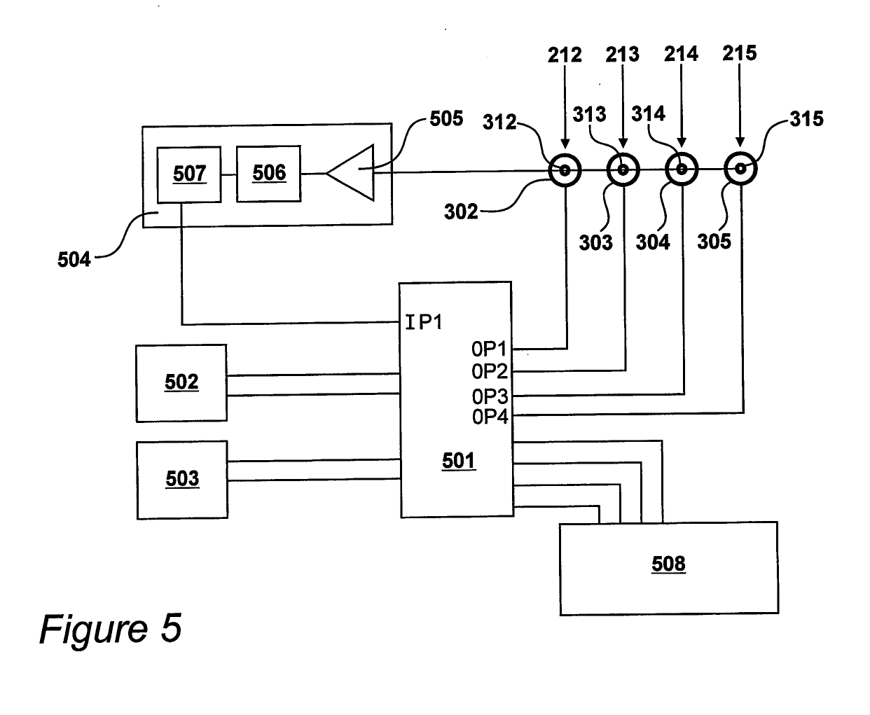

FIG. 5

A diagram of a circuit used to determine the status of the button switches 102 to 105 is shown in FIG. 5. Each of the transmitter electrodes 302 to 305 is connected to a respective low impedance output port OP1, OP2, OP3 and OP4 of a micro-controller 501. The micro-controller operates under instructions received from read only memory (ROM) 502. The ROM 502 and the controller 501 may be part of a single application specific integrated circuit (ASIC). The micro-controller is also in communication with an additional memory device, in the form of an EPROM (erasable programmable read only memory) 503, which may be a plug-in device allowing the operation of the micro-controller to be modified.

The receiving electrodes 312 to 315 of the capacitor devices 212 to 215 are all connected together to the input of analysing electronic circuitry 504. The circuitry 504 comprises of an amplifier 505, a bandpass filter 506 configured to filter the output of said amplifier, and a comparator 507, which takes the output of said filter as its input. The output from the comparator is connected to an input port, IP1, of the micro-controller 501.

The micro-controller 501 also has four output ports connected to drive circuitry 508 which generates drive signals in response to the output signals received from the micro-controller. The drive signals may energise actuators, heaters, lights etc. (not shown) in accordance with the type and function of the appliance 101.

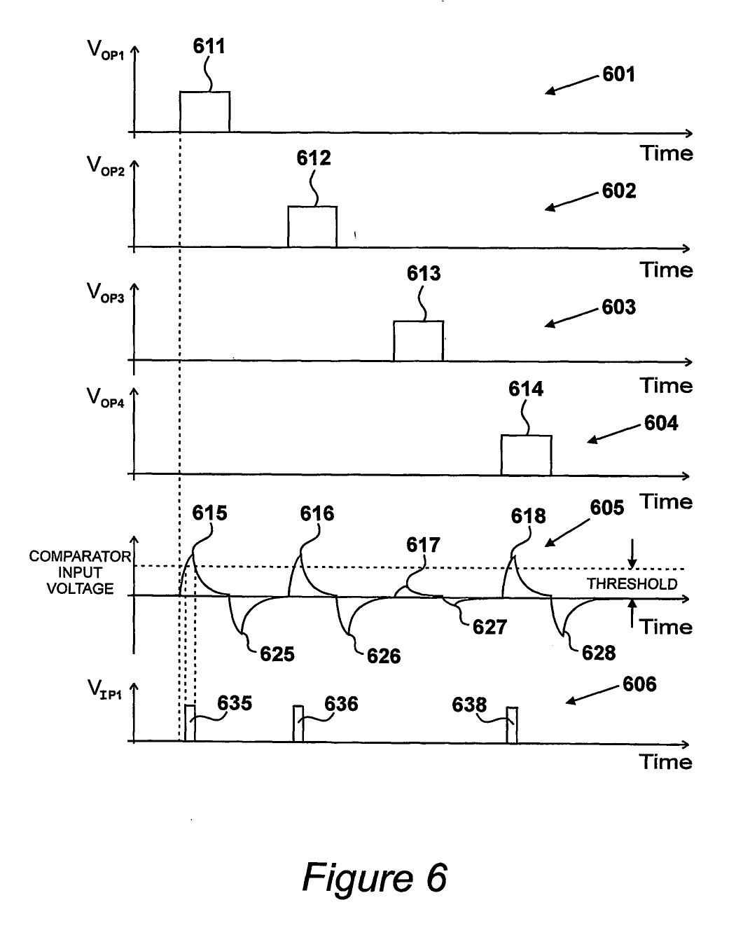

FIG. 6

Signals illustrating the operation of the circuit of FIG. 5 are shown in FIG. 6.

As illustrated by graphs 601 to 604, the controller 501 sequentially outputs, to the transmitter electrodes 302 to 305, a square pulse 611 via output port OP1, a square pulse 612 via output port OP2, a square pulse 613 via output port OP3, and then a square pulse 614 via output port OP4. The sequence is then repeatedly repeated.

An example signal received at the receiving electrodes is shown in graph 605 after amplification and filtering by amplifier 505 and filter 506. The square pulse applied to a transmitter electrode causes charge flow to and from the corresponding receiver electrode. Thus each square pulse generates a positive going pulse 615 to 618 and a negative going pulse 625 to 628 respectively at a receiver electrode.

The filtered signal received at the comparator 507 is compared with a threshold voltage. When the filtered signal is above the threshold voltage a high voltage is supplied to the micro-controller input, and when the filtered signal is below the threshold voltage a low (zero) voltage supplied to the micro-controller input. The graph 606 therefore illustrates the signal received at the input IP1 from the comparator output.

In the present example, it has been assumed that only button switch 104 has been depressed. Consequently, positive going pulse 617 is below the threshold voltage while the other similar pulses 615, 616 and 618 are above it. In response, the comparator outputs square pulses 635, 636 and 638 while the comparator input is above the threshold voltage. It may be noted that, due to the finite rise time of the pulses 615, 616 and 618, there is a delay between leading edge of the square pulses 611, 612 and 614 and the corresponding leading edge of the square pulses 635, 636 and 638.

Following the output of a square pulse to one of the transmitter electrodes 302 to 305, the micro-controller monitors the signal level at the input port IP1 for a subsequent predefined period to determine whether the corresponding switch is depressed. For example, following the output of pulse 611 to switch 102, the pulse 635 received at input port IP1, indicates to the micro-controller that the button switch 102 is not depressed. Whereas, following the output of pulse 613 the voltage on input port IP1 remains low in the subsequent period and thus the micro-controller determines that the button switch 104 is depressed.

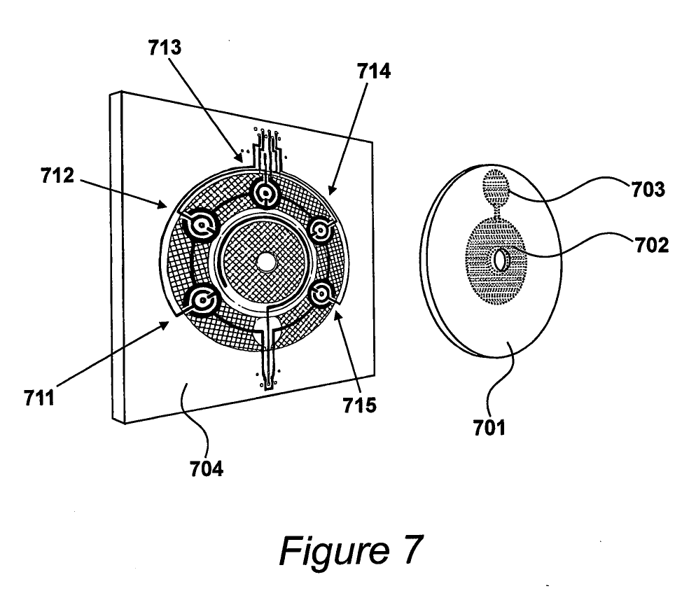

FIG. 7

An exploded perspective view of components of the rotary switching device 106 is shown in FIG. 7. A circular disc 701 is rigidly attached to the manually operable part of the rotary switching device such that it is rotatable about its central axis. The disc 701 has a base made from an insulating material with an electrically grounded conductive region 702 on one of its sides. The disc may thus be made in the manner of a printed circuit board. The conductive region 702 has a circular portion 703 located off-centre so that as the disc is rotated the portion 703 rotates about the disc's axis.

The side supporting the conductive region 702 is parallel to and closely spaced from a printed circuit board (PCB) 704 such that they share a common central axis. The PCB 704 contains five capacitor devices 711, 712, 713, 714 and 715, and it is rigidly mounted within the appliance 101. Consequently, as the disc 701 is rotated it rotates with respect to the PCB 704, and the conductive portion 703 may be located over each of the five capacitor devices in turn. Preferably, the rotary switching device 106 contains a ratchet mechanism (not shown) so that, when the rotary switching device is rotated and released, the conductive portion 703 is brought to rest directly over a capacitor device.

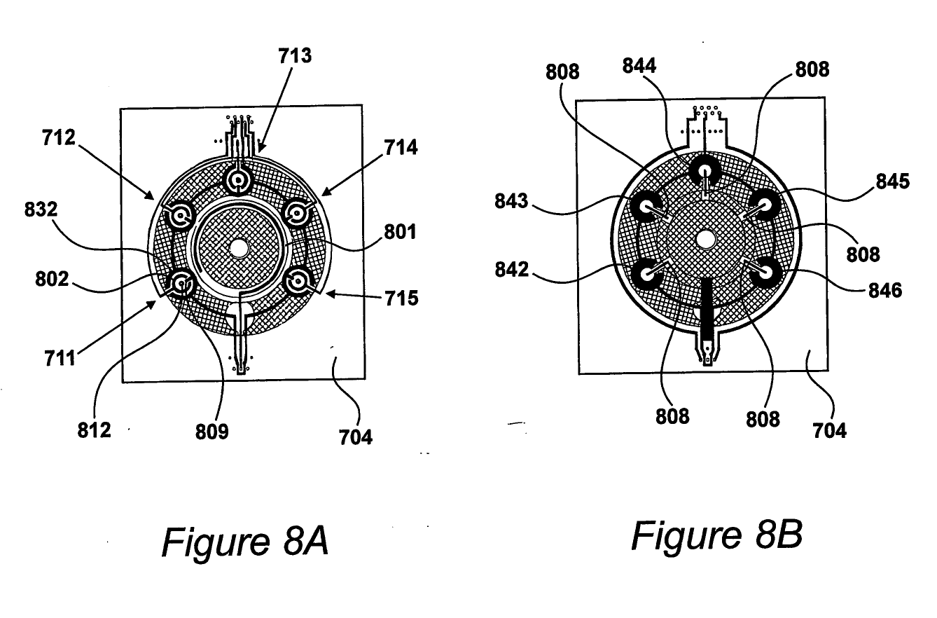

FIG. 8

The PCB 704 is shown in greater detail in the front and rear views of FIGS. 8A and 8B respectively. Each of the five capacitor devices 711 to 715 have a similar structure to the capacitor devices on PCB 206. Thus, capacitor device 711 has a small circular receiver electrode 812 surrounded by a transmitter electrode 802. The transmitter electrode 802 is itself surrounded by an electrically grounded ground electrode 832. The receiver electrodes of each capacitor device are all connected to a single track 801 via plated through holes in the PCB 704 and tracks 808 on its rear surface.

The rear surface of the PCB 704 has arc shaped ground electrodes 842, 843, 844, 845 and 846, which are concentric with the capacitor devices 711 to 715 respectively.

As shown in FIG. 8A, the transmitter electrodes such as electrode 802 form the greater part of a circle but a gap in the circle allows for an extended portion 809 of the ground electrodes, such as electrode 832, to extend inwards towards the transmitter electrodes, such as 812. The extended portion of the ground electrodes has a form and position which corresponds to a section of the tracks 808 on the rear side and thus provides additional shielding for the receiver electrodes.

The effect of the conductive region 703 (shown in FIG. 7) on the capacitor devices 711 to 715 is the same as that of the conductive element 201 on capacitor device 212. Thus, for example, when the conductive region 703 is rotated to a position which is remote from the capacitor device 71 1, the capacitance coupling between the transmitter electrode 802 and the receiver electrode 812 is relatively high and allows a signal applied to the transmitter electrode to be received at the receiver electrode, and, when the conductive region is rotated to a position which is adjacent to said capacitor device, the capacitance coupling is reduced thereby reducing the amplitude of the received signal.

The rotary switching device 106 is incorporated into a similar circuit to that shown in FIG. 5, whereby a manual selection, made by rotating the conductive region 703 over a particular one of the capacitor devices 711 to 715, is received.

In an alternative embodiment, a linear switch array, similar to that shown in FIG. 2, and a rotary switching device, similar to that shown in FIG. 7, share a single PCB. Thus the features of PBC 206 and PCB 704 are produced on a single PCB. Advantageously, the receiving electrodes of the switch array and the rotary switching device are connected together. Consequently, the same analysing electronic circuitry and micro-controller may be used to determine selections made at the switch array and the rotary switching device.

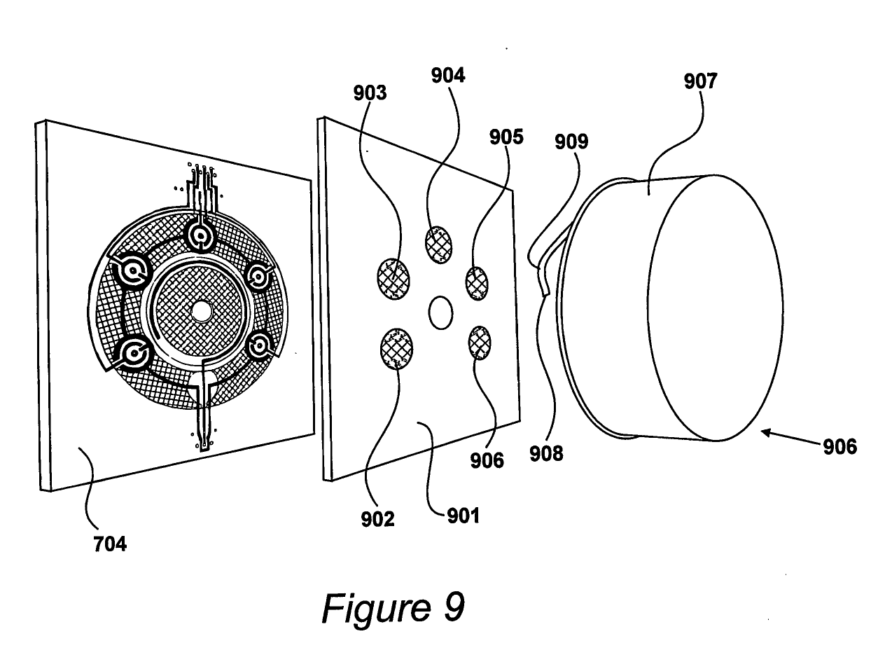

FIG. 9

An alternative rotary switching device 900 is shown in FIG. 9. The device 900 uses the same PCB 704 as device 106. However, the rotatable disc 701 is replaced with an insulating board or sheet 901 which has a fixed location close to, and parallel to, the PCB 704. For example, in this embodiment the PCB 704 and insulating sheet 901 are separated by 1 mm. The sheet 901 is made from a plastics material but in alternative embodiments is made from paper or card. The sheet 901 has five circular regions 902, 903, 904, 905, 906 on its side facing away from the PCB 704, that are coated with a conducting material. The conductive material may be a conductive ink, such as a carbon ink, a silver ink or transparent conductive ink, or a conductive paint etc. The positions of the conductive regions 902 to 906 correspond to those of the five capacitor devices 711 to 715, so that they overlay said capacitor devices.

In common with device 106, device 900 has a rotatable handle 907 allowing manual selection by its rotation. A sprung electrically grounded electrode 908 is rigidly attached to the handle 907. The ground electrode 908 has smooth connecting portion 909 which presses against the sheet 901 and which may be brought into contact with any one of the five conducting regions 902 to 906 by rotation of the handle 907.

During operation, the capacitance coupling between the transmitter electrodes and receiver electrodes of each of the capacitor devices 711 to 715 may be reduced by rotating the ground electrode 908 to a position where it electrically grounds the corresponding conductive region 902 to 906 respectively.

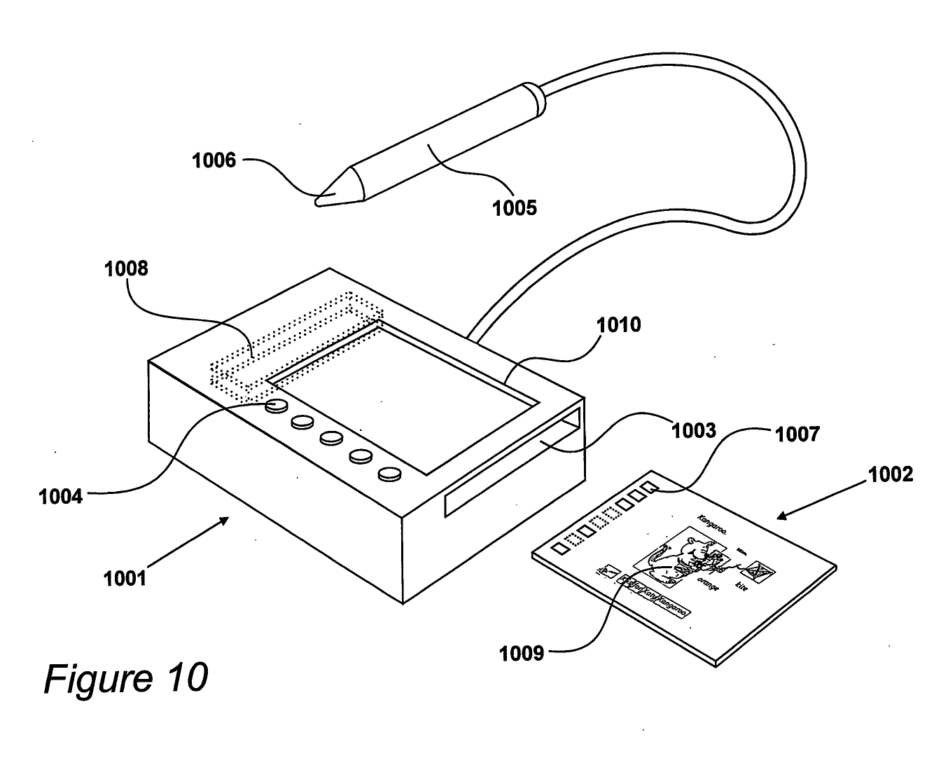

FIG. 10

An electronic apparatus 1001 and a card 1002 used with the apparatus 1001 is shown in FIG. 10. In this instance, the electronic apparatus 1001 is an educational toy for a child.

To use the toy 1001 a card such as the card 1002 is inserted into a slot 1003 in said toy. When it is fully inserted, an image 1009 on the card is viewable through a transparent window 1010 in the upper face of the toy. The toy 1001 is provided with an internal spring loaded arm (not shown) which maintains the position of the card within the slot 1003 while it is being used.

After pressing an “ON” button 1004 a child is able to interact with the toy by indicating selected regions of the card 1002 using a stylus 1005. This is achieved by receiving signals at an electrical receiver located in the stylus tip 1006 that are transmitted by a matrix of linear electrodes within the toy 1001. Devices having such position detection means are known in the art.

The card 1002 is one of many cards which may be used in co-operation with the toy 1001. Therefore, in order to operate correctly, the identity of the card 1002 must be provided to the toy 1001. For this reason, the card 1002 has an identifying code 1007 arranged along an end portion of the card, and the toy 1001 has code reader 1008. The code reader 1008 receives the end portion of an inserted card and identifies it from the identifying code 1007.

The toy 1001 and card 1002 provide an example of the present invention. However, it should be understood that other portable objects supporting code defined by conductive elements may be used with code reading apparatus operating in accordance with the present invention. For example, the code reading apparatus may form part of a security device, such as a door lock, requiring the insertion of a card having a particular code in order to be activated.

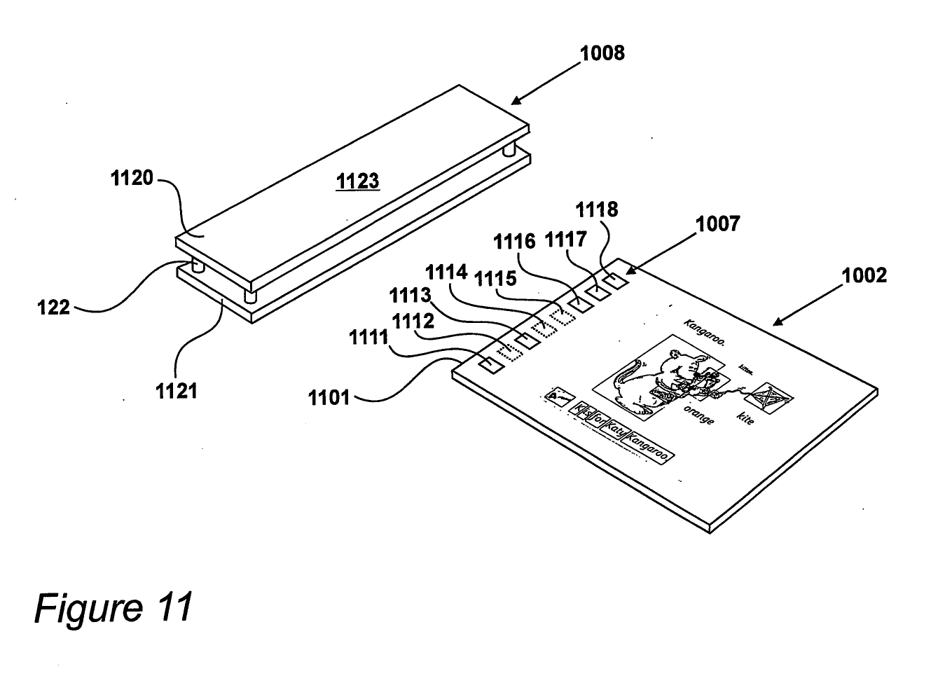

FIG. 11

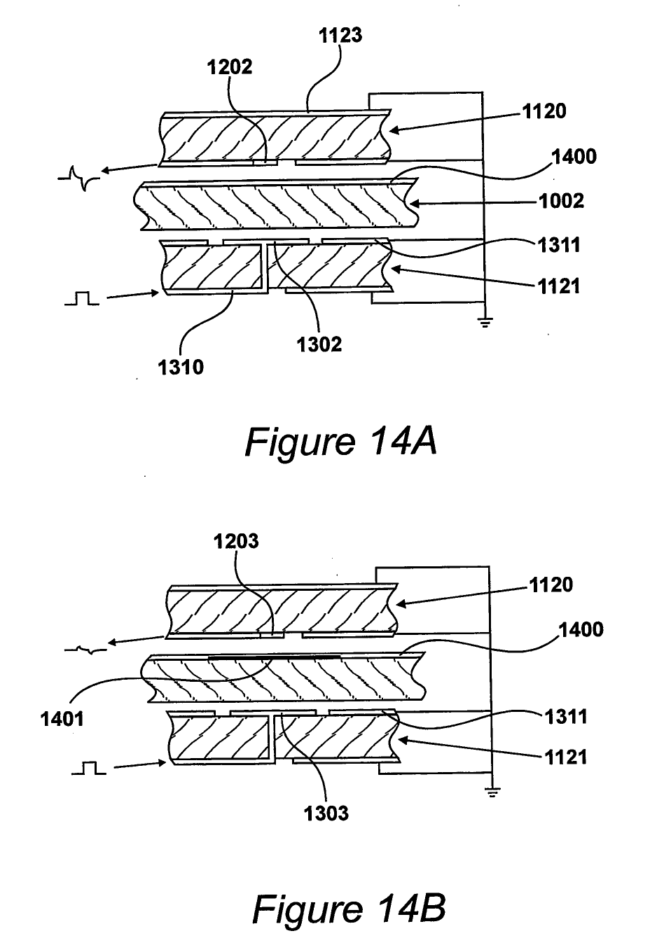

The code reader 1008 and the card 1002 of FIG. 10 are shown in FIG. 11. The identifying code 1007 comprises of a series of conductive pads linearly arranged adjacent the edge 1101 of the card 1002. Cards, such as card 1002, have eight regions 1111 to 1118 inclusive, reserved for the possible application of a conductive pad. One or more of the conductive pads are applied to the card as conductive ink, or paint, during their production. Preferably, the card is subsequently laminated or coated with an insulating protective layer of, for example, a plastics material. (The protective layer 1400 is shown in FIGS. 14A and 14B). Thus the ink is protected from abrasion during use.

The cards, such as card 1002, are individually identifiable by the presence or absence of conductive ink in each of the reserved regions 1111 to 1118. For example, the pattern of the conductive pads may be considered to define a binary code number which identifies the card. For example, card 1002 has a conductive pad at regions 1111, 1113, 1116, 1117 and 1118 while regions 1112, 1114 and 1115 are devoid of conductive material. Thus, the conductive pads on card 1002 define the binary number 10100111, or 167 in base ten. In this way, using eight reserved regions and at least one conductive pad on each card, two hundred and fifty-five different cards may be identified. Alternatively, the cards may have different images on each of their faces so that they may be used either way up. In this case, each face of the card is identified by the identifying code 1007. For example, if card 1002 were turned up side down and edge 1101 inserted into card reader 1008, it would present the binary number 11100101 (two hundred and twenty-nine in base ten) to the card reader. i.e. the reverse of binary number 10100111. Thus, the two faces of the card are individually represented by a single identifying code.

The card reader 1008 comprises of two printed circuit boards 1120 and 1121 spaced apart by spacers 1122. The gap between the PCB 1120 and the PCB 1121 is sufficiently wide to provide a loose fit for the end portion of cards, such as card 1002. Typically, the gap is between two millimetres to five millimetres wide, and preferably it is two millimetres to three millimetres wide. The upper surface 1123 of PCB 1120 is conductive and electrically grounded to provide shielding for receiver electrodes located on it lower surface.

Transmitter electrodes are located on the upper surface of the PCB 1121, and in combination with the receiver electrodes they define eight capacitor devices. Each capacitor device is positioned to receive one of the reserved regions 1111 to 1118 when a card is inserted. The reduction of conductance coupling in one of said capacitor devices, caused by the presence of a conductive pad, allows the card reader 1008 to determine its presence.

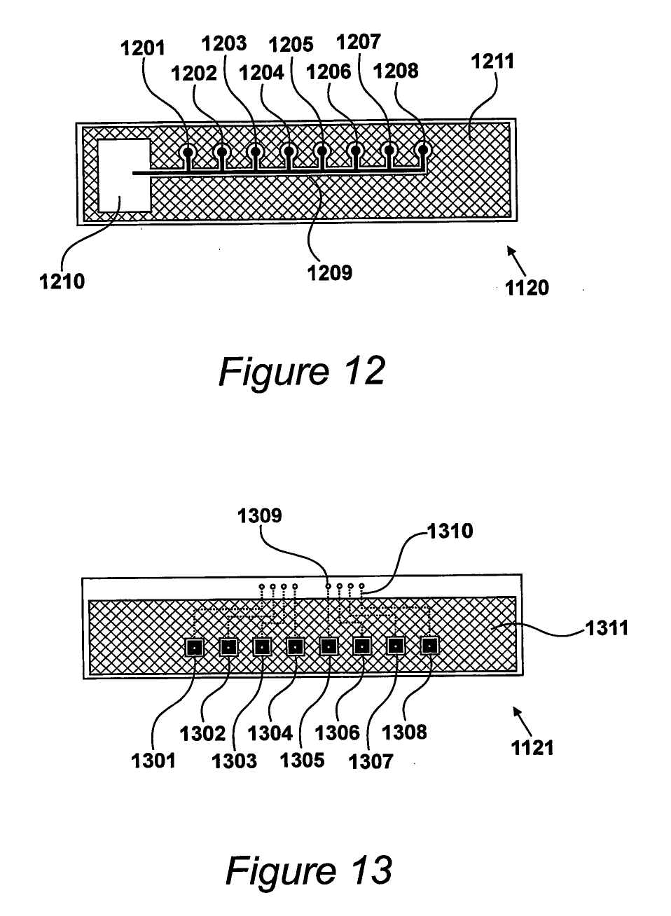

FIGS. 12 and 13

The facing surfaces of the printed circuit boards 1120 and 1121 are shown in FIGS. 12 and 13 respectively. PCB 1120 has eight circular receiver electrodes 1201 to 1208 inclusive, which are linearly aligned and equally spaced. The PCB also supports signal analysing circuitry within a region 1210, and all the receiving electrodes 1201 to 1208 are connected to said circuitry by a single conductive track 1209. A grounded electrode 1211 (shown hatched) surrounds the receiving electrodes 1201 to 1208 and the conductive track 1209, to provide further shielding for the receiving electrodes from electromagnetic noise.

As shown in FIG. 13, the upper surface of PCB 1121 has eight square shaped transmitter electrodes 1301 to 1308 inclusive. The eight transmitter electrodes are positioned such that they face the receiver electrodes 1201 to 1208 when the card reader 1123 is assembled. The transmitter electrodes are connected to terminals 1309 by plated through holes in their centres and conductive tracks on the reverse side of the PCB 1121 (illustrated by dashed lines 1310). A ground electrode 1311 surrounds the transmitter electrodes to provide further screening from electromagnetic noise.

FIG. 14A and 14B

The operation of capacitor devices of card reader 1008 is illustrated in the cross-sectional views of FIGS. 14A and 14B. FIG. 14A shows the capacitor device defined by transmitting electrode 1302 and receiving electrode 1202 while reading card 1002. In operation, a square pulse is applied to the transmitter electrode 1302 via a conductive track 1310. In the absence of a conductive pad, the capacitance coupling between said electrodes remains relatively high, and consequently a relatively high signal is received at receiving electrode 1202.

FIG. 14B shows the capacitor device defined by transmitting electrode 1303 and receiving electrode 1203 while reading the same card, 1002. In this instance, a conductive pad 1401 is present between said electrodes and, consequently, the capacitance coupling between them is reduced to a relatively low value. Therefore, when a square pulse is applied to the transmitter electrode 1303, the presence of the conductive pad 1401 causes a relatively low signal to be received at receiving electrode 1203.

Thus, by supplying a square pulse to each of the transmitting electrodes 1301 to 1308 in turn, and monitoring the amplitude of the pulse received at receiving electrodes, it is possible to determine the identifying code on the currently inserted card.

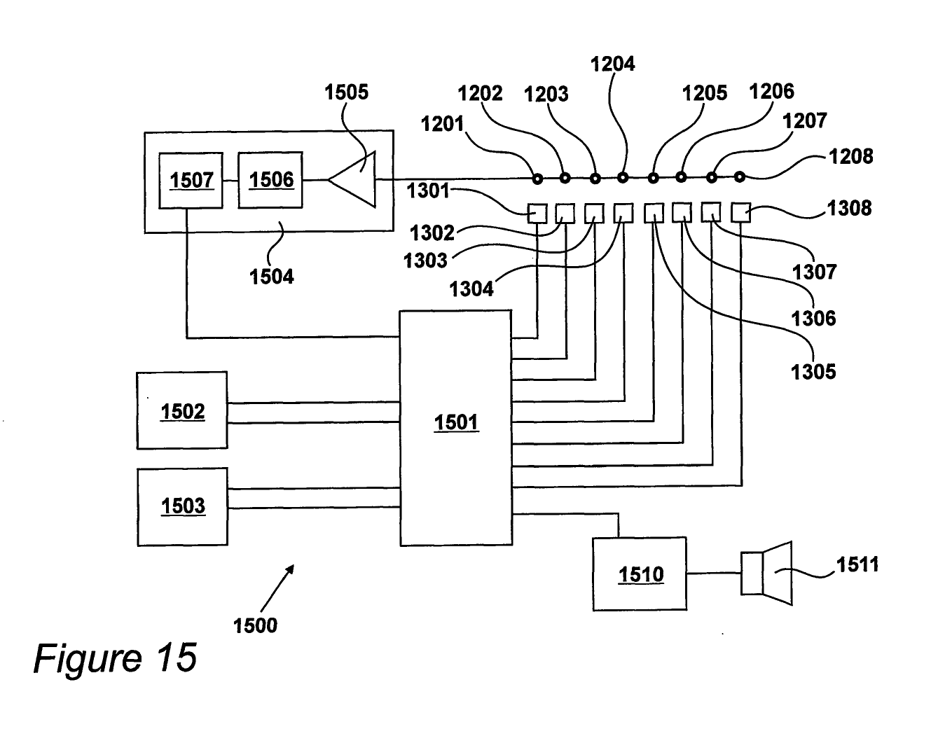

FIG. 15

A diagram of the electronic circuitry 1501 of card reader 1008 is shown in FIG. 15. Many of the components of circuit 1500 are the same as those of FIG. 5 and operate in a similar manner. Thus, circuit 1500 has a micro-controller 1501, in communication with a ROM 1502 and an EPROM 1503. The EPROM 1503 may be configured to be replaceable, so that a particular EPROM which is designed for use with a particular set of cards may be used.

The micro-controller 1501 also receives digital signals from analysing electronic circuitry 1504, itself comprising an amplifier 1505, a bandpass filter 1506 configured to filter the output of said amplifier, and a comparator 1507.

Eight output ports of the micro-controller 1501 are each connected to one of the transmitter electrodes 1301 to 1308. The receiving electrode 1201 to 1208 are all connected to a single input of amplifier 1505.

A ninth output port of micro-controller 1501 is connected to amplifier 1510 which provides signals to an audio speaker 1511. Thus, in response to the identification of a card, signals relating to the card are supplied to the amplifier 1501 in accordance with data stored in EPROM 1503.

The operation of the circuit 1500 is essentially the same as the circuit of FIG. 5. Thus, the micro-controller 1501 supplies a square pulse to each transmitter electrode 1301 to 1308 in turn, and in a following period, it monitors the signal received from comparator 1507. Signals received by receiving electrodes are amplified by amplifier 1505 before being filtered by bandpass filter 1506. The comparator 1507 determines whether the signal goes above a threshold value, and if so then a high output is supplied to microprocessor 1501. Consequently, the micro-controller is able to determine the presence or absence of a conductive pad in each of the regions 1111 to 1118 of a card, and thus determine the identity of said card.

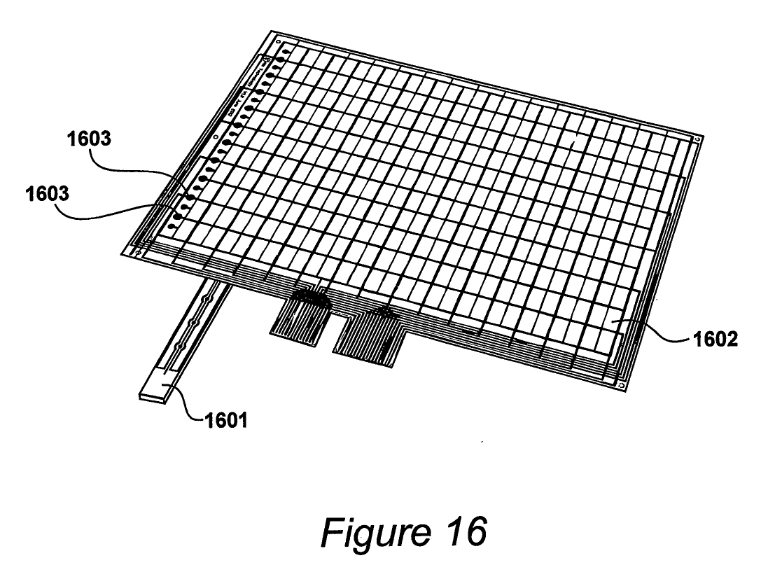

FIG. 16

An alternative card reading arrangement for the toy 1001 is illustrated by FIG. 16. A PCB 1601 has essentially the same structure as PCB 1120 except that it contains ten receiving electrodes, instead of eight. However, unlike the card reader 1008, the corresponding transmitting electrodes 1603 are printed onto a flexible plastic membrane 1602. As well as forming a part of the card reading arrangement, the plastic membrane supports the matrix of linear conductors which are used in co-operation with the stylus 1006 to provide an X-Y position sensing device.

Thus when a card is initially inserted, or the toy is first switched on, signals are supplied via the linear conductors to the transmitter electrodes to identify the card. Having identified the card the matrix is then used in the position sensing mode.

In a further alternative card reading arrangement for the toy 1001, the PCB 1601 is replaced with an extended portion of plastic membrane 1602. Receiving electrodes are printed onto the extended portion, and the membrane is folded such that each of the receiving electrodes is positioned opposite one of the transmitting electrodes 1603. The membrane is folded such that a suitable gap is provided between the receiving electrodes and transmitting electrodes for receiving a card such as card 1002. This alternative arrangement operates in the same manner as those of FIG. 10, or FIG. 16, but has the advantage of not requiring a PCB to provide the transmitting and receiving electrodes.

The receiving electrodes and transmitting electrodes are separated by a gap produced by the folding.

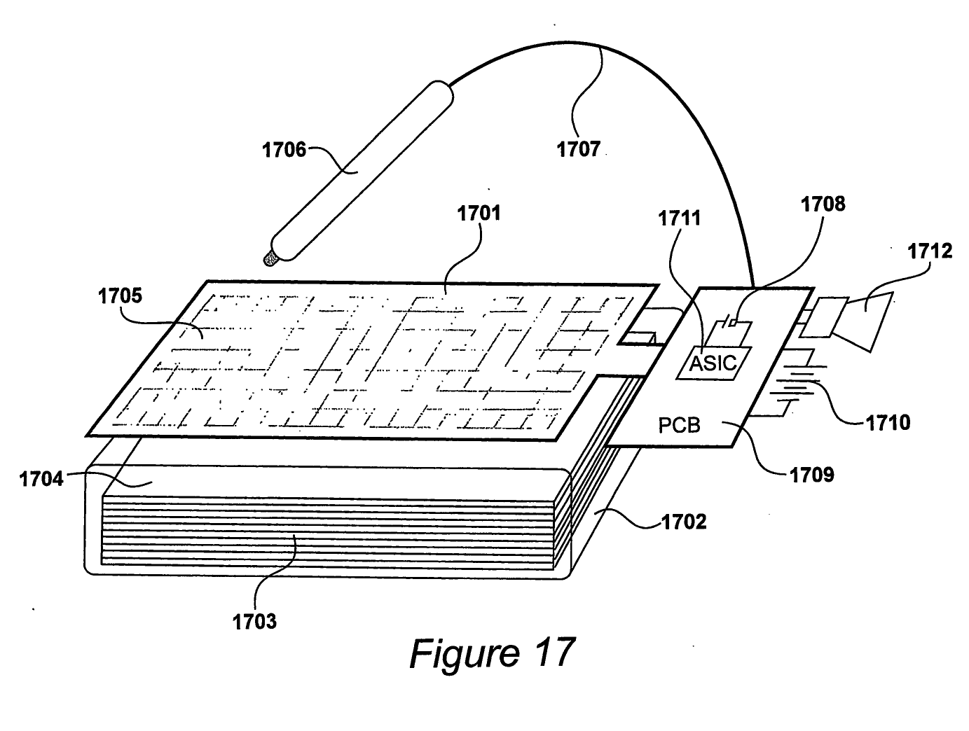

FIG. 17

For effective learning, particularly of language, it is most helpful for a student to have the advantage of considerable attention, if not full time attention, of a teacher. For example, a young child will often learn to read by looking at a book containing pictures and corresponding words with an adult reading the words as the child follows the words and looks at the associated pictures. Thus the mind of the child is focusing on an image depicting something, is being given the spoken word and is seeing the written word. Furthermore, from the context the child is absorbing the word within the scope of a grammatical structure and is gathering the meaning, either from the pictures if relevant or with the aid of an explanation. At any stage the teacher can discuss with the child any word or its meaning or draw to the child's attention a similar word and provide explanations and definitions of grammar and meaning, i.e. syntax and semantics.

Similarly, when a child is beginning to read, the adult can monitor the reading and provide immediate feedback on a one-to-one basis to maximise the rate at which the child gains reading skills and remembers vocabulary. The interest and motivation of the child can be maintained at high levels.

However, apart from a domestic situation, the cost of such teaching techniques makes them prohibitive, yet there is a very substantial need for such additional support, particularly in the areas of adult illiteracy, foreign language teaching and remedial language teaching.

Furthermore, similar needs for feedback and flexible recapitulation of concepts, explanations and facts are needed in many of the areas of education including mathematics and other science subjects. The availability to a student, of a teacher who can be requested to repeat an explanation, elaborate on some point of commentary or deal with any other relevant question is an extremely valuable resource in many situations.

It is known to students with e.g tape recordings of an explanation. When such recordings are applied to the process of learning to read, a simple system is one in which a tape recording of a printed work is given to a student and then student has the opportunity of following the words, repeating segments of the tape recording and indeed recording his or her own attempts at reading the words and comparing with the tape recordings of the tutor. However, such a system is inflexible and hard to operate.

One published approach to the teaching of language is contained in PCT International Publication No. WO 83/02188 (MERIT BOND LIMITED) wherein printed text is provided with bar codes associated with at least some of the text, a manually controlled reading device being used to access the bar codes as the user may require, and an electronic processing means used to cause the apparatus to synthesise voice reproduction corresponding to the text with which the selected bar code is associated. Such a device has limitations in terms of functions fulfilled and in the special preparation required of the printed material, i.e. it can not be used with conventional books.

Another published approach, (PCT WO 87/06752) in the teaching of language is one in which sets of bar codes are arranged on respective lines corresponding to lines of printed text. Each bar code set, when accessed, causing a particular storage location from a message store to be accessed to be reproduced by a speech producer. The limitations of such a system are that a book can not be used in its original format, since bar codes have to be added or overprinted onto the original document at the expense of text. Further, the selection of the bar code set may lead to confusion and small children may have difficulty scanning a bar code.

Yet another published approach (PCT WO 90/15402) relates to a document interpreting system comprising location detecting means on which a plurality of documents to be interpreted may be stacked and for detecting through said documents the location of pointing means directed at an area of the topmost document of said stack, speech storage means for storing speech relating to different areas of said documents and speech reproduction means for reproducing speech stored in said speech storage means corresponding to the area of said topmost document to which said pointing means is directed. In the system disclosed, the pointing means takes the form of a user's finger.

Another published approach (EP 0 572 466) relates to a document interpreting system comprising location detecting means on which a book or other stack of documents may be placed and electronic pointing means coupled to said location detecting means and adapted in use to be directed at an arbitrary area of the topmost document of the stack of documents, said location detecting means being adapted to detect electronically through said stack the location of said arbitrary area to cause speech stored in a speech storage means associated with said arbitrary area to be reproduced.

A disadvantage with the document interpreting system of EP 0 572 466 is that if the stack of documents, for example the pages of a book, contain documents with metallic embossing or if the humidity of the stack of documents is high then there is considerable distortion in the location detection process leading to a shift in the detected position of the pointing means which can lead to speech associated with an incorrect arbitrary area being reproduced.

The present embodiment is directed to a document interpretation system which overcomes the above limitations and provides for a practical and useful device which eliminates the need for specially printed codes associated with the words and phrases of the written material an enables a wide variety of normal books to be used including those having metallic embossing or documents having high humidity.

The document interpreting system depicted in FIG. 17 of the drawings is especially applicable for assisting learning of reading or pronunciation or understanding of words, phrases or sentences or interpretation of drawings, pictures, etc. It should be understood that the term “document” covers any printed matter or indeed any written or drawn matter, and in particular includes books.

The document interpretation system comprises a membrane 1701 which overlies a cartridge 1702 in which are located one or more cards 1703 in the form of a stack. The card to be read by the user (not shown) is placed as the topmost card 1704 where more than one card is present. The cartridge 1702 and membrane 1701 are shown as schematically in FIG. 17. In practise, the membrane 1701 may be housed in a frame formed as part of the upper surface of the cartridge 1702 of fixedly located on, or hinged to the upper surface of the cartridge 1702 by any suitable means. The important aspect is that the membrane 1701 is located in use, or may be brought into location for use, such that it overlies the card or cards 1703 stored in the cartridge 1702.

The membrane 1701 is transparent or at least sufficiently translucent as to allow the user to determine the contents of the topmost card 1704 when viewing through the membrane 1701. The membrane 1701 comprises a grid 1705 formed of conductive stands creating an X-Y pattern dividing the membrane 1701 into substantially squared shaped segments.

The membrane 1701 is formed from a pair of transparent films, one of which defines a set of parallel conductive strands in a first (X) direction, and the second film defining conductive strands in a second (Y) direction perpendicular to the first direction. The transparent films are Orgacon Conductive Transparent Films and the conductive strands are defined by screen printing of Strupas ink. The Orgacon films and Strupas ink are supplied by Agfa-Gevaert N.V., of Mortsel, Belgium.

The membrane 1701, and specifically the grid 1705, is electrically coupled to a printed circuit board (PCB) 1709. The PCB 1709 has mounted thereto an Application Specific Integrated Circuit (ASIC) 1711. The PCB 1709 is further provided with a power source in the form of a battery 1710 and a speaker 1712. The PCB 1709 may be formed as part of the cartridge 1702, as part of the frame housing the membrane 1701, or as part of a separate unit.

The ASIC 1711 is provided with its own power source in the form of a battery 1708. Alternatively, the ASIC 1711 may be powered directly from the PCB battery 1710.

A pen or pointer 1706 is coupled to the PCB 1709 by means of a cable 1707. The pointer 1706 is adapted to be pointed at an area of the membrane 1701 coincident with a arbitrary area of the topmost card 1704 viewed through the membrane 1701 so as to enable the co-ordinate location of the arbitrary area to be detected by the membrane 1701 and in turn determined by the ASIC 1711.

The pointer 1706 is, for example, magnetically or capacitively coupled to the membrane 1701 in use. Importantly, since the relative positions of the membrane 1701 and the pointer 1706 are determined magnetically or capavitively rather than by pressure applied to the membrane 1701, the document interpretation system finds particular application for use with young children who are apt to press randomly and unintentionally on the membrane 1701 whilst using the system. With a membrane activated by pressure such contacts would lead to a large number of false readings and hence confusion to the user.

The ASIC 1711 contains machine code and/or software programs and solid state circuitry to control operation of the pointer 1706, membrane 1701 and speaker 1712. In addition, the ASIC 1711 stores speech associated with areas of the cards 1703.

In use, the output from the grid 1705 of the membrane 1701, consisting of the co-ordinate details of an area of the card 1704 to which the pointer 1706 is directed, is fed to the ASIC 1711 on the PCB 1709. The machine code and/or other software encoded in the ASIC 1711 resolves the co-ordinate details from the membrane 1701 and determines the speech stored in the ASIC 1711 which is associated with the area of the topmost card 1704 to which the pointer 1706 is directed.

It will be appreciated by those skilled in the art that the location of the card 1704 or other document to be read, relative to the membrane 1701, may be established by, for instance, physical means such as the internal dimensions of the cartridge 1702 to ensure the card is placed in a known location relative to the overlying membrane 1701. Alternatively, the card 1704 or other documents may be placed in the cartridge 1702 in any orientation and known features such as corners of the card 1704 may be registered by pointing at them through the membrane 1701 with the pointer 1706 in an initialising registration procedure. By this method the location of the words and pictures, etc. may be calculated by such known means as simple co-ordinate geometry routines.

In addition, it will be appreciated that the ASIC 1711 will need to determine which of the cards 1703 is the topmost card 1704. This may be done, for example, by providing a unique identifier area on each card 103 to which the pointer 1706 is first directed. By arranging for each card 1703 in the stack to have its identifier area in a different position, the ASIC 1711 is able to determine the identity of the topmost card 1704. Alternatively, a manual mechanism may be provided wherein the PCB 1709 is provided with an input terminal by which the user may enter an identifier, e.g and alpha-numeric character or characters, to identify the topmost card 1704.

In use of the system thus far described, a user points the pointer 1706 at an area at the topmost card of the stack of cards 1703, e.g some printed text or a picture. The grid 1705 of the membrane 1701 detects the presence of the pointer 1706 by means of the magnetic or capacitive changes in the grid 1705 of the membrane 1701 caused by the proximity of the pointer 1706. The membrane 1701 outputs signals representing the co-ordinates of the designated area to the ASIC 1711. The machine code or software program embedded in the ASIC 1711 processes the signals and resolves the corresponding co-ordinates and generates a signal instructing the speaker 1712 to output an audio signal corresponding to speech corresponding to the printed text pointed to on the card 1704 or alternatively corresponding to the picture pointed to on the card 1704.

Optionally, the user of the system can access a button or switch either on, for example the stylus-to give a real voice reply of individual words when touched by the pointer 1706. Alternatively, another button may be provided which when accessed causes reproduction of the whole sentence when the first or any word in that sentence is touched by the pointer 1706. Another button may be provided which when accessed allows the user to receive prompts, such as a suggestion to look the syllables within the word selected or the system can be set up to sound out the word phoneme by phoneme. A further button may be provided which, when accessed by the user, will give an explanation of the word or picture which may be in terms of its definition, mode of usage or other commentary.

The system may also be used for teaching a second language, in which case, for example, a sentence can be reproduced in both languages in the correct idiom for each language using two different buttons, e.g on the cartridge 1702. Each word can also be represented in each language, word for word, by the selection an appropriate button. Where complex multi-syllable foreign words are being taught, the word may be represented both in its normal presentation at normal dictation speed and also by a further selection at a slowed down speed enabling the student to dissect the pronunciation of the word, syllable by syllable.

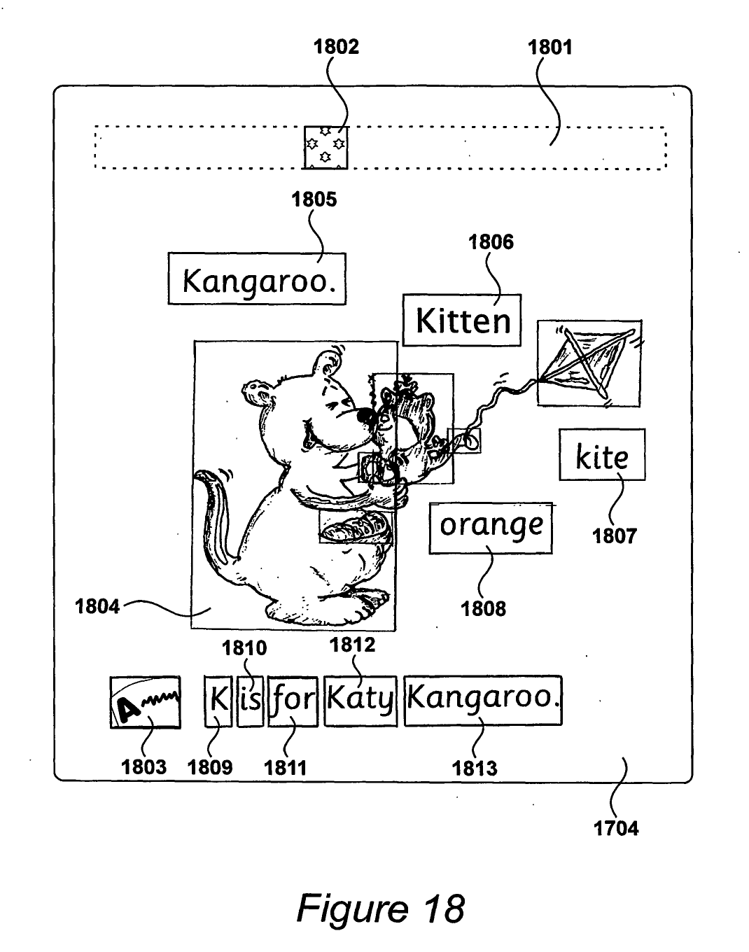

FIG. 18

Some examples of the use of the system described with reference to FIG. 17 will now be described with reference to FIG. 18 which depicts the topmost card 1704 of FIG. 17 in greater detail.

Referring to FIG. 18, a rectangular area 1801 is reserved on cards 1703 for displaying a unique identifier. Thus card 1704 has a unique identifier 1802 within the area 1801. Consequently, using pointer 1706 of FIG. 17 to point to rectangular area 1802 identifies card 1704 to the document interpretation system of FIG. 17.

Using pointer 1706 to point to area 1803 would cause the sentence “K is for Katie kangaroo” to be reproduced. Pointing to area 1804 may cause the phrase “hello I am Katie kangaroo” to be reproduced.

Pointing in each of the areas 1805 to 1813 inclusive would cause the individual words “kangaroo”, “kitten”, “Kite”, “Orange”, “K”, “is”, “for”, “Katie” and “Kangaroo”, respectively, to be reproduced.

It should be appreciated that the rectangular areas referred to in FIG. 18 are used by a way of example only and other shaped areas, such as a circular shaped areas may be used.

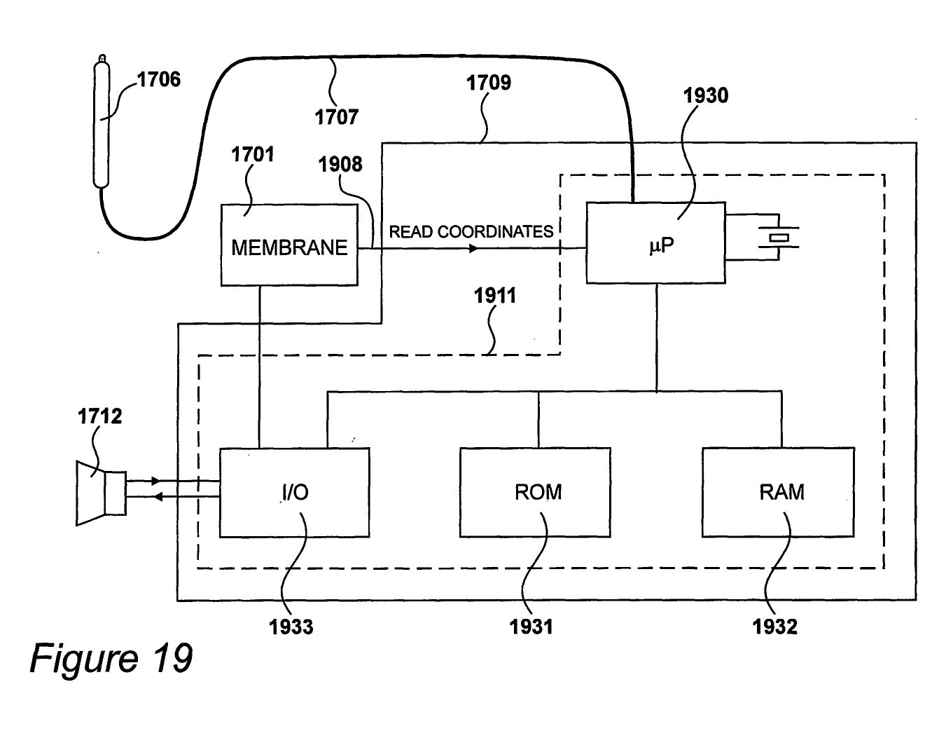

FIG. 19

In FIG. 19 of the drawings, there is shown a block schematic diagram relating to the document interpretation system of FIG. 17. This comprises the membrane 1701 which affords and output 1908 to the PCB 1709, which is itself connected to the pointer 17806 via the cable 1707 and to the speaker 1712.

The PCB 1709 has mounted thereon the ASIC 1711 which typically comprises a microprocessor 1930 which operates under the control of a program stored in read only memory “ROM” 1931 and receives the signals representing the co-ordinate details via output 1908 from the membrane 1701. A random access memory (RAM) 1932 is provided in which is stored the speech signals corresponding to the various areas of the documents being read, e.g the cards 1703. The micro processor 1930 outputs the speech signals to the speaker 1712, via an input/output (I/O) interface 1933 which causes the speech signals to be reproduced by the speaker 1712.

It is envisaged that that random access memory 1932 may take the form of a removable RAM-card in which the various speech signals are stored corresponding to the different areas if the cards 1703, thereby enabling a set of cards 1703 and associated RAM-card to be sold as a package.

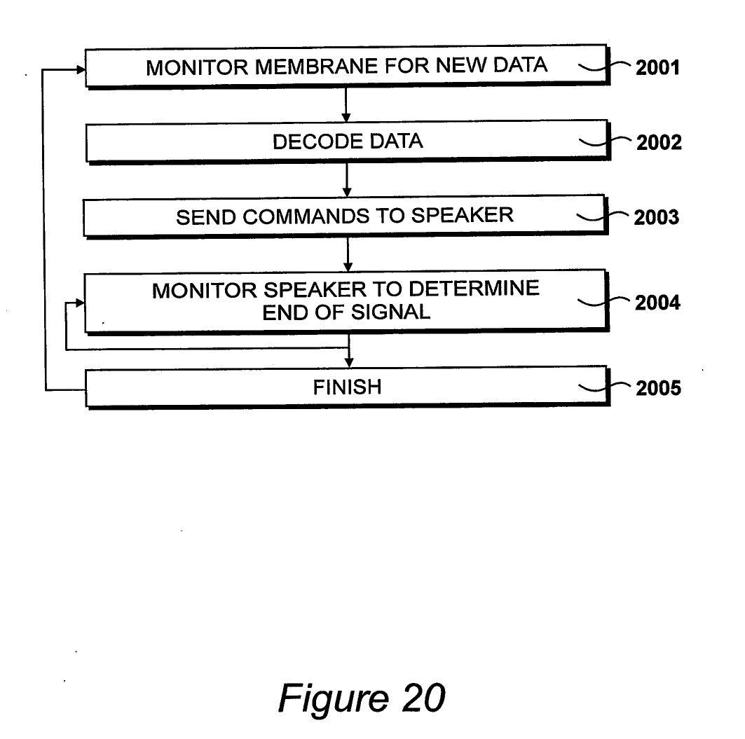

FIG. 20

In FIG. 20 of the drawings there is shown a flow diagram of a typical operating system of the arrangement depicted in FIG. 19. At step 2001, the micro-processor 1930 monitors the membrane 1701 for new data. The new data is decoded at step 2002 to obtain the corresponding speech signal stored in the RAM 1932. At step 2003, the speech signal is output to the speaker 1712, the output of which is monitored by the micro-processor 1930 via the I/O interface 1933, at step 2004, to determine the conclusion of the speech signals corresponding to the selected area. The system is then ready for re use.

It will be appreciated that new cards, or locally generated documents, e.g. flash cards and picture stories, may have their textual and pictorial co-ordinates recorded by means similar to that of FIG. 17 with the system operating in a “writing” mode. In this mode the co-ordinates of individual words, pictures, phrases, etc. are read, via the pointer 1706, from cards placed in the cartridge 1702 under the membrane 1701 by the program in the read only memory 1931 (FIG. 19). These co-ordinates are then converted into the corresponding speech signals stored in the random access memory 1932 for subsequent use in the “reading” mode described above.

The document interpreting system which has been described is advantageous in that it enables normal printed or written documents to be “read” without special overprinting of bar codes, magnetic codes, etc. The system can also operate with documents containing metallic embossing or having pages with high humidity content. RAM-cards and sets of cards 1703 may also be sold as a package in respect to particular items for use by teachers, pupils, etc. on equipment in many different locations.

It should be appreciated that the document interpreting system which has been described has been given by a way of example only and various modifications may be made dependent upon any particular application. Although the pointer 1706 has been shown as connected to the PCB 1709 by means of a cable 1707, it may be remotely connected to it using, for example, an infrared, radio or other link. Also, although the use of an ASIC 1711 in conjunction with a speaker has been described, other speech storage systems may be used, such as using tape or compact disk and associated player. Other output devices may also be used such as headphones.

Further, whilst the set of cards 1703 has been described as being stored in a cartridge 1702, other means of locating the cards 1703 relative to the membrane 1701 may be utilised, for example, by clipping or otherwise temporarily fixing the card 1704 or cards 1703 to the underside of the membrane 1701.

Further, a mechanism may be provided to enable the cards 1703 in the cartridge 1704 to be shuffled so as to change the identity of the topmost card 1704. For example, an aperture may be provided in the cartridge 1702 to allow the stack of cards 1703 to be removed, manually shuffled and reinserted into the cartridge 1702.

The system may also be used with documents other than individual cards 1703. For example, the system may be used with complete books wherein the membrane 1701 is placed over each page of the book in turn. Advantageously, means may be provided, such as a book stand, for holding the book at rest with the membrane 1701 hinged thereto such that the membrane 1701 may be hinged upwards away from contact with the page of the book to allow for the pages to be turned. The membrane 1701 may then be hinged back down into contact with the subsequent page of the book.

Another form of document that may be used with the system is a scroll comprising an elongate document wound onto one or a pair of rollers. In use, the roller or rollers can be rotated so as to bring the required portion of the document into line with the membrane 1701.

Further, while it is important that the membrane 1701 is transparent or at least translucent, the membrane 1701 may be manufactured to be flexible or inflexible. In particular, where the membrane 1701 is flexible, a separate strengthening member may be provided, for example, a frame to stiffen the membrane 1701.

1. A mechanically operable electrical device, comprising a transmitter electrode, a receiver electrode and a moveable conductive element, wherein:
said device is configured such that said conductive element is moveable to a first position remote from said electrodes such that said transmitter electrode is capacitance coupled to said receiver electrode; and
said conductive element is moveable to a second position closer to said electrodes such that said capacitance coupling is reduced.

2. A mechanically operable electrical device according to claim 1, wherein said device comprises a ground electrode which is grounded in use to electromagnetically shield said receiving electrode.

3. A mechanically operable electrical device according to claim 1, wherein said conductive element is continuously grounded during use.

4. A mechanically operable electrical device according to claim 1, wherein said transmitter electrode and said receiver electrode are located in the same plane.

5. A mechanically operable electrical device according to claim 1, wherein said conductive element is not electrically connected.

6. A mechanically operable electrical device according to claim 1, wherein said receiving electrode is positioned on a separate parallel plane to said transmitting electrode.

7. A mechanically operable electrical device according to claim 1, wherein said conductive element in said second position is located between said transmitter electrode and said receiver electrode.

8. A mechanically operable electrical device according to claim 1 wherein said transmitter electrode is formed on a printed circuit board.

9. A mechanically operable electrical device according to claim 8, wherein said printed circuit board is a membrane which forms part of a position sensing device.

10. A mechanically operable electrical device according to claim 1, wherein said transmitter electrode and receiver electrode are one of a plurality of such pairs of transmitter electrodes and corresponding receiver electrodes; said conductive element is one of a number of conductive elements located on a portable object to define an identifying code; and said portable object is configured to be manually inserted between said transmitter electrodes and said receiver electrodes, whereby the capacitance coupling between each transmitting electrode and the corresponding receiver electrode depends upon the presence of a conductive element on said portable object.

11. A mechanically operable electrical device according to claim 1, wherein said device is configured as a manually operable switch.

12. A mechanically operable electrical device according to claim 11, wherein said device further comprises one or more additional pairs of transmitter electrodes and receiver electrodes, and said conductive element is moveable by rotation to other positions in which it is closer to one of said pairs of electrodes.

13. Code reading apparatus, and a coded object having one or more conductive regions at defined locations to define a code, wherein said device comprises:
a plurality of capacitor devices each having a transmitter electrode and a capacitance coupled receiver electrode;
a signal generating device configured to supply a signal of a predetermined type to each said transmitter electrode; and
a signal analysing means for analysing a received signal received by said receiving electrodes,
wherein said code reading device is configured to receive said one or more conductive regions of said coded object such that the capacitance coupling between the electrodes of one or more corresponding capacitor devices is modified, whereby the signal received at one or more corresponding receiving electrodes is modified.

14. Code reading apparatus according to claim 13, wherein said coded object is a card.

15. Code reading apparatus according to claim 13, wherein said code reading apparatus is a toy and said coded object is one of a plurality of coded cards, each card being individually identified by conductive regions defining a code.

16. Code reading apparatus according to claim 15, wherein said card has images on each of its faces, and said apparatus is configured to identify the displayed face from said code.

17. Code reading apparatus according to claim 13, wherein said code reading apparatus forms part of security apparatus.

18. A mechanically operable electrical device, comprising a transmitter electrode; a receiver electrode capacitance coupled to said transmitter electrode; a conductive element adjacent to said transmitter electrode and said receiver electrode; and a ground electrode, wherein
said ground electrode is moveable between:
(a) a first position in which said conductive element is not electrically grounded such that capacitance coupling between said transmitter electrode and said receiver electrode is relatively high; and
(b) a second position in which said conductive element is electrically grounded whereby said capacitance coupling is reduced.

19. A document interpreting system comprising location detecting means under which may be placed one or more documents and for detecting the location of pointing means directed at an area of a topmost document of the one or more documents, speech storage means for storing speech relating to different areas of said one or more documents, and speech reproduction means for reproducing speech stored in said speech storage means corresponding to the area of said topmost document to which said pointing means is directed, wherein said pointing means comprises electronic pointing means coupled to said document interpreting system and adapted in use to be directed at an arbitrary area of said topmost document, said location detecting means being arranged to detect electronically the location of said arbitrary area for causing speech stored in said speech storage means corresponding to the arbitrary area of said topmost document to which said pointing means is directed to be reproduced, wherein said location detecting means comprises a transparent or translucent membrane through which the electronic pointing means is directed at the arbitrary area of said topmost document.

20. A document interpreting system as claimed in claim 19, wherein the membrane comprises co-ordinate detecting means for affording an output corresponding to the co-ordinate location of said electronic pointing means on said topmost document.

21-33. (canceled)
